(19) United States
(12) Patent Application Publication
(10) Pub. No.: US 2018/0232262 A1
(43) Pub. Date: Aug. 16, 2018

(54) MAPPING HETEROGENEOUS APPLICATION-PROGRAM INTERFACES TO A DATABASE

(71) Applicant: CA, Inc., Islandia, NY (US)

(72) Inventors: Mubdiu Reza Chowdhury, Islandia, NY (US); Andrew C. Kidder, Islandia, NY (US); Bilal M. Bhatti, Islandia, NY (US); Lee Chastain, Islandia, NY (US)

(21) Appl. No.: 15/433,300

(22) Filed: Feb. 15, 2017

(51) Int. Cl. G06F 9/54; G06F 17/30

(52) U.S. Cl. CPC G06F 9/541; G06F 17/30991; G06F 17/30958

(57) ABSTRACT

Provided is a process, including: obtaining a first application-program interface (API) response from a first software-as-a-service (SaaS) application API, the first API response being arranged according to a first data-serialization format; retrieving a first connector schema from memory based on a mapping in memory of the first connector schema to the first SaaS application API, wherein the first connector schema comprises a plurality of rules by which API responses from the first SaaS API are processed to form nodes or edges of a graph data structure; applying the rules of the first connector schema to at least part of the first API response from the first SaaS application API to form a plurality of nodes and a plurality of edges of the graph data structure; and updating the graph data structure in memory to include the plurality of nodes and the plurality of edges.

### BACKGROUND

### 1. Field

The present disclosure relates generally to distributed computing and, more specifically, to mapping heterogeneous application-program interfaces to a database.

### 2. Description of the Related Art

Recently, many software applications have migrated to the cloud. Often, user-facing and back-end software applications execute on remote computer systems hosted by various third parties. Examples include productivity suites, calendaring applications, email, document management platforms, enterprise resource planning applications, project management applications, and various databases.

Frequently, these applications support programmatic access (e.g., to retrieve data, write data, delete data, or execute other commands) via an application-program interface (API). Generally, APIs have a structure similar to a function call from one part of a program to another (e.g., with an identifier of the function and various parameters), except that the API command is often sent to another computer system over a network. APIs are not unique to cloud applications, as many on-premises installations also present APIs, and APIs are also used to communicate between programs on a single computing device.

### SUMMARY

The following is a non-exhaustive listing of some aspects of the present techniques. These and other aspects are described in the following disclosure.

Some aspects include a process, including: obtaining a first application-program interface (API) response from a first software-as-a-service (SaaS) application API, the first API response being arranged according to a first data-serialization format; retrieving a first connector schema from memory based on a mapping in memory of the first connector schema to the first SaaS application API, wherein the first connector schema comprises a plurality of rules by which API responses from the first SaaS API are processed to form nodes or edges of a graph data structure; applying the rules of the first connector schema to at least part of the first API response from the first SaaS application API to form a plurality of nodes and a plurality of edges of the graph data structure; and updating the graph data structure in memory to include the plurality of nodes and the plurality of edges.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a flowchart showing an example of a process in accordance with some embodiments;

FIG. 2 is a block diagram of data model transformations effected by some embodiments of the process of FIG. 1;

FIG. 3 is a block diagram of a physical and logical architecture of a computing environment in which the techniques of FIGS. 1 and 2 may be used; and

FIG. 4 is an example of a computer system by which the above techniques may be implemented.

While the inventions are susceptible to various modifications and alternative forms, specific embodiments thereof are shown by way of example in the drawings and will herein be described in detail. The drawings may not be to scale. It should be understood, however, that the drawings and detailed description thereto are not intended to limit the inventions to the particular form disclosed, but to the contrary, the intention is to cover all modifications, equivalents, and alternatives falling within the spirit and scope of the present inventions as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of computer science. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

As noted, APIs are often used by one program to invoke functionality in another program, e.g., in the same computing device, on the same local area network, or in the cloud. APIs, however, present problems due to a lack of standardization across different applications, and particularly different software-as-a-service (SaaS) applications. Often applications expose various APIs, but in many cases the same action on different applications correspond to different API commands, often having different formats and different sets of arguments. Compounding this challenge, the format of data exchanged via such commands also is API-specific and different among the different APIs. In essence, many of these applications speak different languages for machine-to-machine exchanges. This can present relatively acute challenges when a program interfaces with a heterogeneous, diverse set of third party APIs, particularly when members of the set change frequently, and the APIs undergo regular revision. Hard coding new custom middleware for each new API and each revision of an API can become unmanageable.

Further, the data structures by which data is exchanged via many APIs can slow certain computations. Often, APIs (and particularly representational state transfer (REST)-based SaaS APIs) normalize data in a format that privileges entities over relationships between entities. For instance, the data may be conveyed in a format that tracks the structure of tables in a third normal form relational database, e.g., with API responses being a list of rows of a given table, each row describing attributes of an entity or pointing to rows of other tables. In this scenario, it can be relatively slow to perform certain computations that implicate relationships between the entities, and particularly those that cross tables or API responses. Relatively computationally taxing join operations (and often many join operations) may be performed to ascertain the relationships, thereby slowing the operation of the computer system, particularly when relatively large data sets are at issue. (None of which is to suggest that embodiments are inconsistent with use of relational databases or some join operations, as various engineering tradeoffs are envisioned, and multiple independently useful inventions are described.)

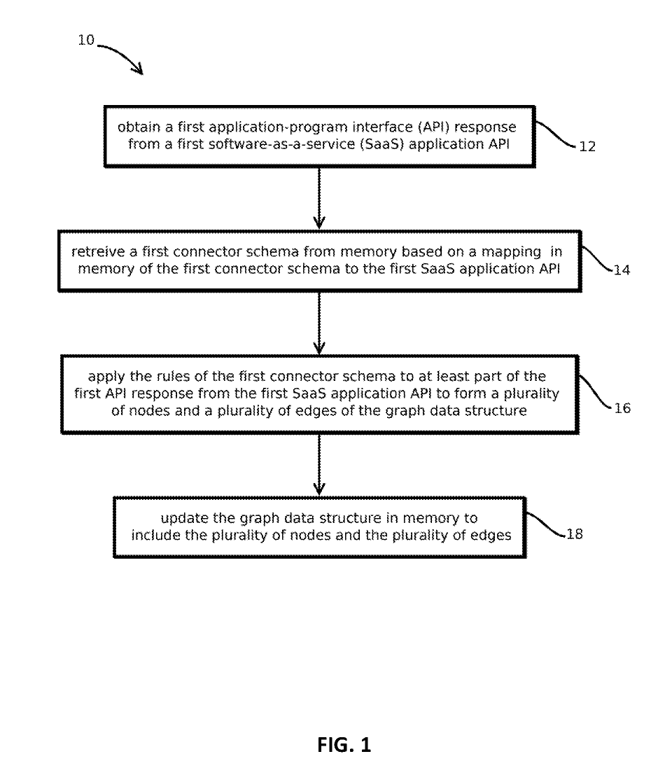

FIG. 1 is a flow chart of an example of a process 10 that may mitigate some of the above-described issues or, in some cases, offer various other advantages that are apparent from the operations described. In some cases, instructions that when executed by one or more computers effectuate the process 10 may be stored on a tangible, non-transitory, machine-readable medium, as is the case for the other processes described herein. Further, in some cases, the process 10 may include additional steps, the steps may be performed in a different order or concurrently, and some steps may be omitted, as is the case for the other processes described herein, and which is not to suggest that any other feature described herein is not similarly amenable to variation. The process 10 is first described with reference to data being retrieved from an API, but as described below, the process may be reversed to update a third party SaaS application with more current data resident in a local data structure.

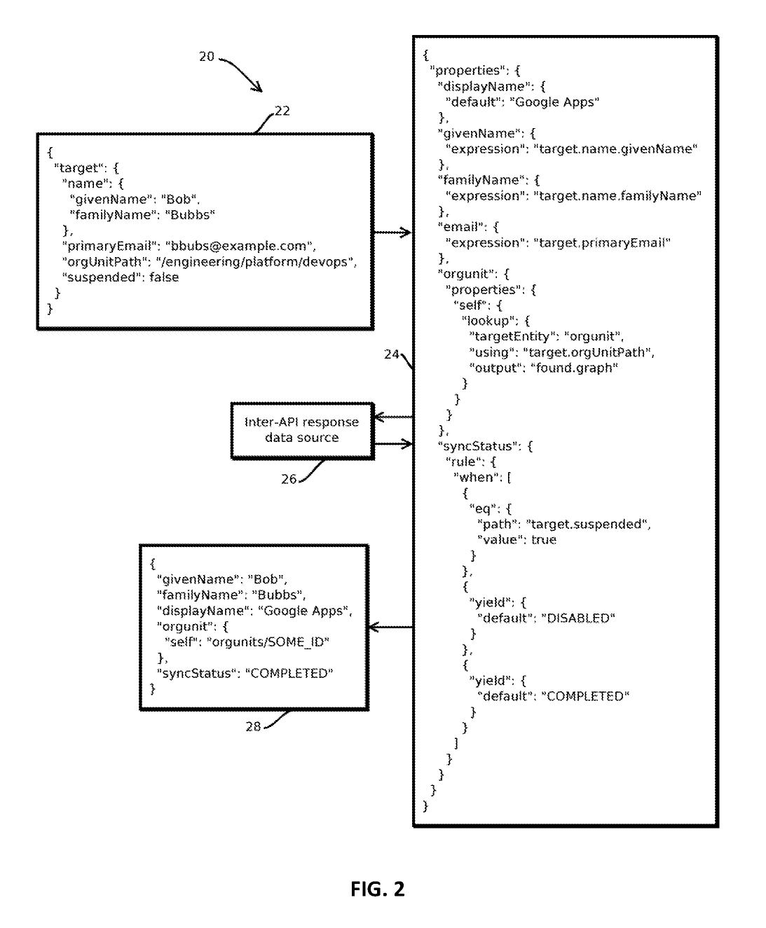

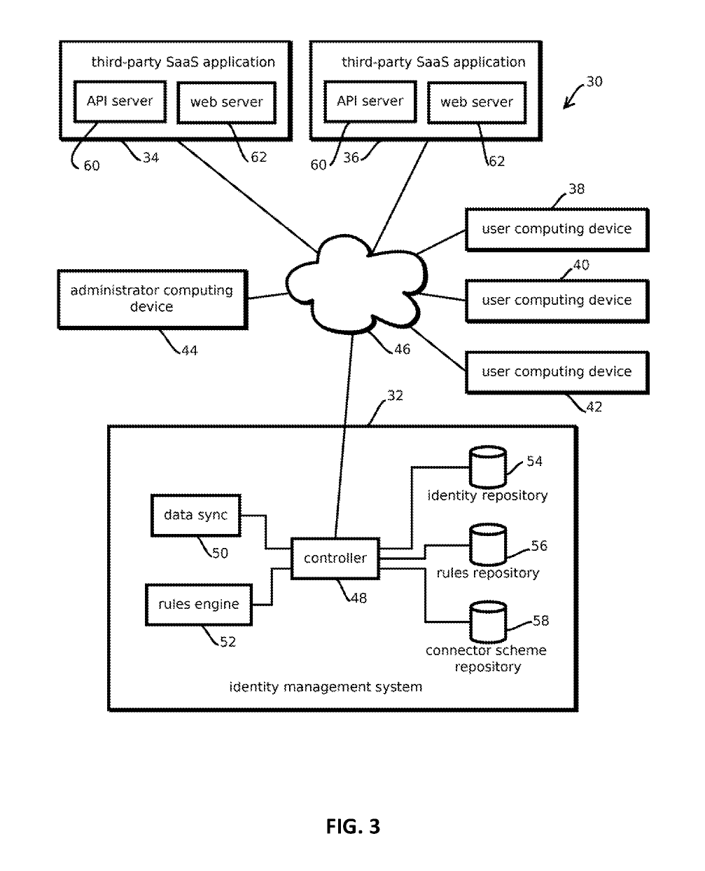

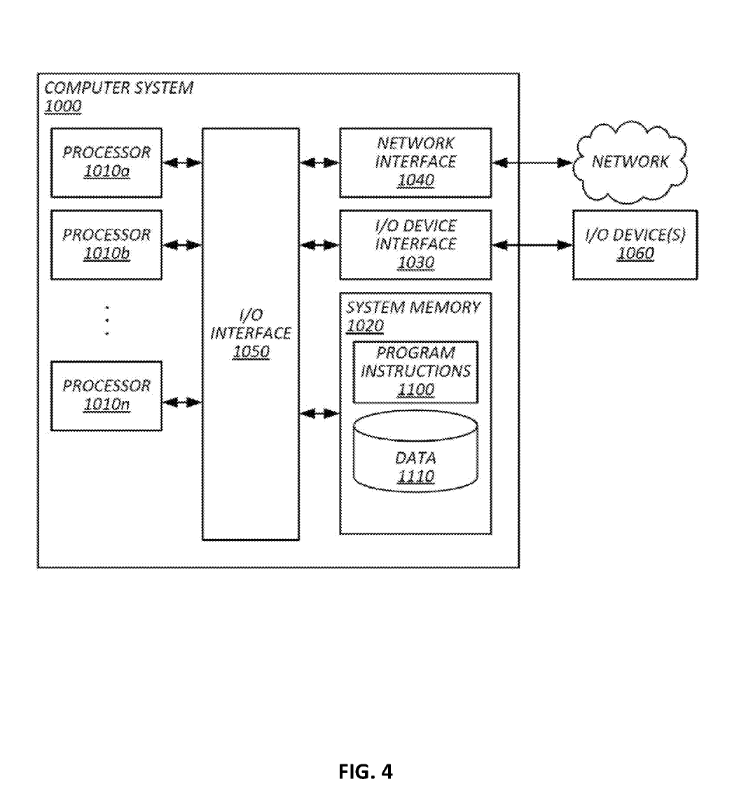

In some embodiments, the process 10 may be executed within a computing environment described below with reference to FIG. 3, implementing data transformations described below with reference to FIG. 2, in some cases implemented with one or more of the computer systems described below with reference to FIG. 4. FIG. 3 shows one example set of use cases, in the context of identity management. It should be emphasized, though, that the process 10 and variations thereon may be implement in other systems, for instance, designed for other use cases, as the techniques described herein are expected to be broadly applicable.

In some embodiments, the process 10 includes obtaining a first API response from a first SaaS API, as indicated by block 12. In some cases, the first API response may be obtained after sending a request to an API server, examples of which are described below, and receiving a response over the Internet. In some cases, the API, and corresponding request and response, may be structured according to a REST protocol. In some embodiments, a corresponding request may be encoded as Hypertext Transport Layer Protocol (HTTP) requests, such as GET or POST requests to a uniform resource locator (URL) with a command and parameters, or in other application or lower layer protocols, and the response may be encoded as a HTTP response. In some cases, the protocol is stateless on the server-side, and session state may be held in the computing device sending an API command and receiving the response. In some cases, exchanges via the API are synchronous.

In some embodiments, the process 10 may be initiated in response to a variety of different events, depending upon the use case. In some embodiments, the process 10 may be initiated upon determining that a database is to be synchronized with one or more remote APIs, such as one or more remote REST-based APIs accessed over the Internet. For example, records in a local database (e.g., on the same local area network or in the same computing device as that executing portions or all of process 10) may be added, deleted, or updated. Some embodiments may respond by executing the process 10 to synchronize those changes with corresponding records in third party SaaS applications accessible via one or more respective APIs.

In some cases, as described below, the local database may be a graph-based database storing a graph data structure and configured to expedite computations implicating relationships between entities relative to traditional relational databases. In some embodiments, the graph data structure may be a connected graph data structure or an unconnected graph data structure having multiple unconnected sub graphs. In some embodiments, the graph data structure may include a plurality of nodes and edges extending between those nodes, for example, forming pairwise links between respective pairs of nodes. In some embodiments, the nodes and the edges may have various attributes. For example, some of the edges may be weighted edges with cardinal values indicating a strength of a relationship between the respective nodes connected by the respective edge. In some embodiments, the edges may be directed edges, with an associated direction indicating a direction in which a relationship reflected by the edge operates, for example, indicating that one node is possessed by another node, one node is a member of a group corresponding to another node, one node likes another node, and the like. Similarly, in some cases, the nodes may have attributes, for instance, indicating various scores, fields, and the like that reflect the state of a node. In some cases, these attributes of nodes and edges may be encoded as key-value pairs, with a key indicating a field or name of the attribute, and a value indicating a value of the attribute.

As explained in greater detail below, graph data structures are expected to yield faster operation than is available with more traditional relational databases for certain use cases. For instance, many relational databases do not directly encode relationships between entities, and when queries implicate those relationships, query responses or other database operations may be relatively slow. For instance, often certain relational database operations require joining of separate tables to take responsive action, and this can be a relatively slow operation. Traditionally, to expedite some forms of these operations, some relational databases maintain indexes that provide relatively fast access to such relationships, but these indexes often constitute redundant information within the database that can slow database updates and various other database operations beyond queries, as multiple redundant records may need to be updated.

In contrast, graph databases explicitly encode relationships between entities and directly link those relationships to the entities, for instance as edges extending between nodes. As a result, there is generally no (or a reduced) need to maintain additional indices for direct relationships between entities, thereby affording relatively fast changes to the database and relatively fast queries and other operations that implicate relationships between data (e.g., a query for every node that has a particular relationship with a given node, or a set of given nodes having some attribute). In some cases, such data structures may be characterized as having index free adjacency, meaning that adjacent nodes, or nodes sharing an edge are directly indicated in the data structure, without the need to maintain a separate index. Databases may be characterized as having an index free adjacency for the present purposes where the database is more than 50% index free. Further, it should be understood that the term database may refer to a subset of a larger data structure which may include other types of data and other formats, e.g., a hybrid database having both a graph database and a relational database. Further, it should be noted that some of the present techniques may be implemented without using a graph database, e.g., exclusively within a relational database or other type of database, as various independently useful inventions are described.

As noted, however, many API responses are normalized differently than the data is arranged in a graph data structure. Further, in many cases, the data is formatted differently across APIs, with different field names for similar or the same types of values and different data formats for the same instances of various types of values, like dates, addresses, names, and the like. Accordingly, some embodiments may execute the process 10 in the course of synchronizing a graph data structure and data accessible via such APIs to transform the data into a canonical format suitable or relatively fast queries and database operations implicating relationships between entities.

Further, as noted, many systems in the future are expected to synchronize data with an even more diverse set of SaaS (and on-premises) applications accessible via a relatively diverse set of APIs, many of which are expected to have different formats, often with formats that change frequently over time. Managing translation between a graph data structure and these diverse and changing API formats is expected to be relatively complex, both due to the diversity and the changing nature of the target systems hosting the APIs and due to the complexity of any given translation. To mitigate these issues, some embodiments may implement a domain specific language, referred to as a “connector schema,” which provides a relatively powerful and expressive way of describing these transformations, such that even relatively diverse, rapidly changing sets of third-party APIs can be effectively managed and synchronized with a graph data structure (or other canonical representation).

The SaaS application may be any of a very wide variety of different applications. Examples include applications having both a web interface and an API. Further examples include applications (also or alternatively) having an interface accessible via a special-purpose application, such as a special-purpose native application executing on a mobile computing device. For example, the SaaS application may be a web-based email application, document management application, bug tracking application, customer relationship management application, enterprise resource management application, human resources application, chat application, social network application, calendar application, workflow management application, project management application, or the like. Indeed, it is expected that most enterprise applications in the future will be SaaS applications having an API, though it should be understood that the present techniques are also consistent with on premises applications, many of which also include APIs amenable to the present techniques.

The present techniques are consistent with a variety of different types of APIs. In some embodiments, the API is a REST-based API. In other embodiments, the API is a non-REST API. In some embodiments, the API is a Simple Object Access Protocol (SOAP) API. In some cases, the API is an asynchronous API, e.g., implementing a websocket connection using promises or deferreds.

In some embodiments, the first API response may be received arranged according to a first data serialization format. In some cases, the data serialization format specifies a hierarchical arrangement of the data, for example in JavaScript™ object notation (JSON) or extensible markup language (XML). In some cases, the data serialization format further specifies an encoding scheme for the data, for example ASCII or Unicode. In some cases, the data serialization format specifies a namespace of the data, for instance with a URL that responds with a document indicating strings corresponding to fields listed as keys in key-value pairs encoded in the responsive data from the API response. For example, two different API responses may both be encoded in Unicode, as JSON, but have different name spaces, thereby constituting two different data serialization formats. Or various other aspects of the data serialization format may vary between two different API responses from two different APIs. In some cases, generally, the same API is expected to generally adhere to the same data serialization format through multiple API responses, though in some cases different versions of a given API may result in different data serialization formats over time. In some embodiments, API responses may identify the version of the API to which the data serialization format corresponds, and some API responses may include identifiers of name spaces, such as URLs pointing to descriptions of corresponding name spaces. In some cases, API responses may be characterized as having a schema, or in some cases, API responses may be characterized as schema-less, for instance as documents amenable to variation in the format of the data.

In a specific illustrative example, some embodiments may send a request to an API for a web-based email SaaS application, and the request may include a URL, a command, and various arguments for the command, like a command requesting email accounts associated with a user identifier, e.g., with delimiters between the URL, and command, and the parameters. In this example, the user identifier may serve as an argument in the command, depending upon the API. In this example, a response may include a body of JSON including lists and dictionaries with key-value pairs indicating things like the user's first and last name, email address, date that the email address was created, descriptions of filters created by the user for the email address, forwarding addresses, and the like. Specific illustrative examples are described in greater detail below with reference to FIG. 2.

Next, some embodiments may retrieve a first connector schema from memory based on a mapping in memory of the first connector schema to the first SaaS application API (which may be version specific), as indicated by block 14. In some embodiments, the connector schema indicates how to translate between records in a graph database and a given API corresponding to the connector schema. In some embodiments, each API to which a graph database is synchronize may have a respective connector schema. In some embodiments, synchronization includes synchronizing only a subset of data resident in either system.

In some embodiments, the connector schemas may be encoded hierarchically to facilitate relatively fast access to relevant subsets of the schema and to lower the cognitive burden of programmers writing and managing such schemas. In some embodiments, the schemas may include mappings between name spaces, for instance identifying a name of a field and an API response and a corresponding name of some element of the graph database, like a node, and edge, or an attribute thereof. In some embodiments, identifying the field in the API response may include identifying a path through a hierarchy by which the API response is organized, for instance expressing and XPath query or a JSONpath query. In some cases, such paths or other queries may include a sequence of field names separated by delimiters indicating a transition to a lower layer of the hierarchy. For instance the expression “target.name.given_name” may indicate an API response, the field “name” at a first hierarchy, and the subfield “given_name” at a lower level of hierarchy within the API response. Thus, specific value of interest may be identified relatively concisely and precisely within the connector schema, along with a mapping to a key in a namespace of the graph data structure (or other canonical representation).

In some embodiments, additional operations may be specified in addition to indicating that a given field and the namespace of the graph data structure corresponds to a result of a query in the namespace of the API response. For instance, some embodiments may execute operations like validating the data. Examples of validating the data in the API response according to the connector schema include the following applied to a query result from the API response: determining whether certain values required by the connector schema are present (and emitting an error upon detecting their absence); determining whether certain required formats for the values required by the connector schema are present (and emitting an error or reformatting upon detecting their absence); determining whether certain ranges of values required by the connector schema are satisfied (and emitting an error upon detecting a value outside of the range); or determining whether certain regular expressions required by the connector schema to yield a result do return a result (and emitting an error when no result is returned). The term query in this context should be understood relatively broadly and includes queries specifying a path through a hierarchical serialized data format (or regular expressions), as well as searching for various field names in other data formats, like non-hierarchical serialized data formats, such as comma separated values.

Other operations that may be specified by the connector schema include normalizing the data selected from the API response based on a query of the API response. Examples include formatting addresses, telephone numbers, dates, times, names, geolocations, and the like according to a canonical format of the graph data structure (or for translating in the other direction, from the graph data structure, to the API, reverse normalization operations may also be specified).

In some embodiments, the operations may include evaluating conditional branches within the connector schema. For instance, the connector schema may include a rule specifying that if and only if a given value is present, then an additional subset of operations specified within the connector schema are to be executed in response. For instance, the connector schema may include a conditional branch specifying that for each address within a user's address book for an email account, additional operations are to be performed upon those addresses, such as additional API requests, or queries of some other local (e.g., internal) data structure, like the graph database, are to be performed, or each of those addresses is to be normalized, validated, counted, or the like.

In some embodiments, the connector schema may specify that queries are to be performed based on results yielded from other parts of the connector schema, for instance queries with results yielded by other parts of the connector schema as parameters of the query. For instance, a given API response may list the email accounts associated with the user identifier, but the API response may not return groups to which those email accounts belong, such as discussion threads, departmental organizations, distribution lists, and the like. In some embodiments, a connector schema may specify that a user identifier obtained via another part of the connector schema from the API response is to be included in as a parameter in a subsequent query for groups to which that user identifier or email account identifier belongs. In some embodiments, the connector schema may then specify how to translate and otherwise process the resulting data, in some cases, yielding additional queries based on the responsive data or other conditional branches to be executed.

In some cases, the connector schema may specify a plurality of queries, such as one query for each item returned by another portion of the connector schema. In some cases, the connector schema may specify an external query, such as another API request to the same SaaS API. Or in some cases, the API request may be to a different SaaS API, for instance between a calendar and email SaaS application provided by the same entity. In some embodiments, the additional queries may be internal queries, such as querying data currently extant within the graph data structure. For instance, a given connector schema operation may yield an identifier of a node within the graph data structure, and some embodiments of the connector schema may then specify that each node connected to that node with a specified relationship, such as being members of a group corresponding to the node, is to be retrieved.

In some embodiments, the connector schema may specify that particular operations are to occur concurrently or iteratively until some condition is satisfied, such as until some conditional branch evaluates to true or false. In some embodiments, the connector schema may be a statefull connector schema, such as one in which various counters may be incremented until thresholds are met, or in some embodiments, one part of the connector schema may pass parameters to another part or define and write to local or global variables. Or, in some embodiments, the connector schema may be a stateless, functional expression of operations, in which state is not maintained. Stateless connector schemas are expected to be more robust to programming errors and facilitate concurrent operations (as race conditions may be avoided by the lack of state). In some cases, the connector schemas are expressed in a domain-specific functional programming language.

In some embodiments, retrieving the first connector schema may include forming the connector schema from a hierarchy of connector schemas. For instance, some embodiments may include a base connector schema including operations typically consistent among a plurality of different APIs from a plurality of different entities, and the operations of that connector schema may be inherited by sub-connector schemas that adjust or augment that connector schema, like with operations consistent among a plurality of different APIs specific to a given entity. Finally, a sub-sub connector schema may inherit the operations of the sub-connector schema and adjust or augment that connector schema with operations specific to a given API of the given entity. Or in some embodiments, this sub-sub connector schema may be further modified by a lower-level connector schema specific to a given version of the given API from the given entity. Organizing connector schemas in this fashion is expected to facilitate relatively fast access to relatively granular and specific connector schemas addressing a relatively large set of relatively diverse APIs that change over time and lower the cognitive burden on those writing new connector schemas, as portions of the connector schemas may be inherited from higher level connector schemas, and other portions may be abstracted away to lower level connector schemas.

Next, some embodiments may apply the rules of the first connector schema to at least part of the first API response from the first SaaS API to form a plurality of nodes and a plurality of edges of the graph data structure, as indicated by block 16. In some cases, this may include traversing the first connector schema to identify a subsequent operation. In some cases, the operations of the connector schema may be executed concurrently or sequentially. In some embodiments, some of the operations may be amenable to concurrent processing, while others must be process sequentially, for instance, those operations depending upon the result of some input to a conditional branch, at least for some stateful connector schema embodiments. In some embodiments, the connector schema may specify with labels which operations are amenable to concurrent processing and which require sequential operation (e.g., in a hybrid connector schema with stateful and stateless portions), and some embodiments may parse the connector schema to identify the labels and take advantage of concurrent operations for appropriately labeled operations, for instance, by distributing the concurrent operations among multiple processes, like executing on multiple threads or multiple computing devices, to yield faster results on relatively large data sets in some cases, relative to serial operations (though embodiments are also consistent with exclusively serial operations, which is not to imply that any other feature is not also amenable to variation).

As noted, in some embodiments, the connector schemas may include hierarchical arrangements of operations, in some cases with conditional branches and reference to other connector schemas. In some cases, these connector schemas may be characterized as having a tree data structure, for instance, having a root node, and various branches leading to leaf nodes where various operations may occur, with nodes here referring to nodes different from those in the target graph data structure, and the tree data structure being a different graph from that of the graph data structure to which or from which data is being translated. In some cases, the connector schema may be characterized as an abstract syntax tree. Some embodiments may traverse this tree with a variety of different techniques. For instance, some embodiments may traverse the tree with a depth first tree traversal. For instance, some embodiments may identify a root of the tree and traverse down along a branch of the tree to a leaf node before backtracking to a next closest branch. In some cases, a tree traversal function may call itself recursively with a subset of the tree extending from each branching node encountered. As a result, the tree may be sequentialized into operations, e.g., in pre-order, in-order, or post-order. Trees of connector schemas amenable to concurrent operations (or such portions of hybrid schemas) may also be traversed with other techniques, such as breadth-first traversal.

In some embodiments, applying the rules of the first connector schema may include executing the above-described queries for the API response, such as paths through a hierarchical arrangement of API response data, on the API response to retrieve responsive values. For instance, some embodiments may translate a hierarchical serialized data format into a corresponding hierarchical arrangement of data in memory, like in nested sequence of objects having various attributes in program state of an object oriented programming environment, and then parse such a query to navigate through this arrangement of objects to refine the responsive data. In some embodiments, those objects may be held in program state to facilitate relatively fast selection of responsive results, though not all embodiments provide this or the other benefits described herein, as various independently useful inventions are described with various tradeoffs, e.g., some API responses may exceed available system memory and may be retrieved from storage and processed as a stream rather than holding the entire response in memory.

In some embodiments, applying the rules of the first connector schema includes designating such query results from the API response as pertaining to a field (also called a key) in a namespace of the graph database (or other representation). In some embodiments, applying the rules of the first connector schema further includes validating the responsive values and normalizing the responsive values in accordance with the techniques described above.

Further, as noted above, applying the rules may further include evaluating conditional branches and selecting additional operations of the connector schema to be executed responsive to the results or forming and sending or applying various queries having as arguments results of preceding operations of the first connector schema. As noted, in some cases, this may include forming additional queries in the form of additional API requests to the first SaaS API, to other APIs, or to the graph data structure, for instance querying data retrieved with a previous API request and previously translated and added to the graph.

A variety of techniques may be used to determine whether a query specified by the connector schema should be an external query or an internal query. For example, when a query is expected to return values implicated in multiple evaluations of the connector schema, or multiple evaluations of subsets of the connector schema, some embodiments may sequence the external query earlier in the process, and then specify an internal query for those subsequent evaluations of the first connector schema, thereby limiting the number of external queries, and repeatedly executing internal queries against the responsive data in untranslated form. This is expected to yield faster operations, as often external queries are slower than internal queries, though again, not all embodiments afford this benefit, as various independently useful inventions are described.

It should be noted that the plurality of nodes in the plurality of edges of the graph data structure of block 16 need not yet be stored in the version of the graph data structure stored in memory, as the graph data structure may include such values not yet written to the data structure and which are scheduled to be written, such as a new email account retrieved and translated from the first API response but not yet written to the graph data structure in memory. Thus, in some cases, these elements may be referred to as nodes and edges even though they have not yet been written to the graph data structure in memory.

Next, some embodiments may update the graph data structure in memory to include the plurality of nodes and the plurality of edges, as indicated by block 18. In some embodiments, update in the graph data structure may include creating a new graph data structure or modifying and extant graph data structure. In some embodiments, updating the graph data structure to include a plurality of nodes and the plurality of edges may include modifying existing nodes or edges or writing new nodes or edges or in some cases deleting nodes or edges that the first API response indicates have been deleted from the target SaaS application.

The above example focuses on a synchronization operation in which a graph data structure in memory is modified to more closely reflect information resident in a third party SaaS application, but synchronization operations may be performed in both directions using similar techniques. For instance, in some cases, a connector schema may specify that various queries upon the graph data structure are to be performed and various API commands are to be sent to corresponding SaaS APIs, including data responsive to the queries to update the SaaS application to reflect data currently stored in the graph data structure. In some embodiments, these operations may include the data validation and normalization operations described above, except modified to satisfy the requirements each specific API (e.g., the same semantic value, like a street address or date, may be emitted in different formats for different APIs). Further, in some embodiments, these operations may include conditional branches and queries based on previous connector schema operation results using techniques like those described above. Thus, some embodiments may translate data between a graph data structure and relatively diverse, frequently changing sets of third-party APIs relatively quickly on relatively large data sets. Further, some embodiments may implement such operations with a domain specific language that makes it relatively easy for programmers to manage this process and configure this process. That said, various independently useful inventions are described, and not all embodiments necessarily afford all of these benefits.

FIG. 2 is a data flow 20 showing a concrete example of an API response 22, a portion of a connector schema 24, an inter-API response data source 26, and a resulting output data structure 28 suitable for updating a graph data structure. It should be emphasized that this example is merely illustrative, like the other examples herein, and the relatively specific expression of this example, should not be read to imply a narrow range of use cases for the present techniques. The illustrated example pertains to translating between a graph data structure and a web-based SaaS email service, but similar techniques may be for various other types of applications, including the examples described above.

In this example, the SaaS API response may be a response to a request for data describing a email account pertaining to a user identifier specified in the request. In this example, the response is a JSON document, having a hierarchical arrangement of dictionaries and lists, and containing attributes of the corresponding email account responsive to the API command. For instance, the dictionary key “name” includes a dictionary of key-value pairs, including “given name” and “family name.” Each of these keys has a corresponding value, in this class “Bob” and “bugs,” respectively.

Block 24 includes a portion of an example of a connector schema configured to translate between the API response format and a format suitable for updating a graph data structure. In this example, the connector schema includes a plurality of operations similar to some of the examples described above. For instance, within the graph data structure namespace, the key of “first name” is used to denote the same semantic reference as the term “given name” and the API response. In this example, the schema connector is also expressed as a JSON document, including dictionaries and lists with key-value pairs. As shown, a key of “first name” is associated with a dictionary having a key of “expression” and a corresponding value of “target.name.given name”. This operation indicates that the key of first name corresponds to the key of given name in the API response and the path to retrieve the corresponding value, in this case starting at a highest level of target, navigating down to the dictionary key of name, and then navigating down to the dictionary key of given name (when the operation is executed). In this example, the expression is a query having a delimiter between hierarchy levels of “.”. In some embodiments, the queries may be even more expressive, for instance, using operators of)(Path or JSONpath, including wild card characters and regular expressions to match various attributes. Similarly, the differing name spaces use the terms “primary email” and “email” for similar semantic referents.

Thus, upon processing the connector schema 24 and encountering the operation “target.primary email” and the context of the dictionary key of “email,” some embodiments may select the value under the dictionary key of “target,” and from the value, which in this case is another dictionary, embodiments may select the value of the dictionary key “primary email,” which in this case is “bbubs@example.com.”

In this example, the connector schema 24 includes an operation that specifies another query having an argument of the query information based on the API response 22. In this example, the API response 22 specifies a user, but the API response 22 does not identify organizational units, or other groups, to which the user belongs. Thus, some embodiments include operations like that described in connector schema 24 to perform subsequent lookups to retrieve that information (which may be in a different API response). In this example, the operation is noted by the dictionary key of “look up”. In this example, the query includes as a parameter designated by the term “using” of “target.orgUnitPath” included in the first API response 22. Some embodiments may query a node designated as an “orgunit,” as is indicated by the “targetEntity” query parameter at the specified path and output a portion of the result specified by the “output” dictionary key. In this case, the resulting response from the graph data structure is mapped to the dictionary key of “orgunit,” as indicated by the schema connector 24. In some cases, these queries may be to the inter-API response data source 26. In some cases, this data source may be an external data source, such as a query in the form of an API requests to a third-party API, or in some cases, this inter-API response data source may be a query to an internal data source, such as the graph data structure in memory or otherwise resident on another computer system.

Block 28 shows an example of an output yielded by executing the operations of the schema connector 24 on the input API response 22, augmented by query responses from the inter-API response data source 26. In this example, the output is expressed as another JSON document, in this case, with some elements of the JSON document corresponding to nodes, for instance as attributes of nodes, like “givenName” and “familyName” of a node corresponding to a user account. In this example, the dictionary key “orgunit” corresponds to another node in the graph data structure, in this case designated as “set orgunits/some ID,” which may represent for instance, various organizational units in a business, like sales, engineering, management, shipping, and the like. In this case, the association of the designator “self” and “orgunit” indicates a relationship between the node corresponding to the user account and the node corresponding to the group, in this case membership within an organizational unit. Some embodiments may generate a series of graph database operations to update the graph database based on the key-value pairs in the output data structure 28. Of note, the JSON document 28 makes explicit some relationships that are otherwise revealed by performing the slower operation of joining the data sources 22 and 26. Thus, subsequent related operations may be expedited.

FIG. 3 is a block diagram of a computing environment 30 in which the above-describe techniques may be implemented, though it should be emphasized that this is one example of a variety of different systems that are expected benefit from the presently described techniques.

As enterprises move their applications to the cloud, and in particular to SaaS applications provided by third parties, it can become very burdensome and complex to manage roles and permissions of employees. For example, a given business may have 20 different subscriptions to 20 different SaaS offerings (like web-based email, customer resource management systems, enterprise resource planning systems, document management systems, and the like). And that business may have 50,000 employees with varying responsibilities in the organization, with employees coming and going and changing roles regularly. Generally, the business would seek to tightly control which employees can access which SaaS services, and often which features of those services each employee can access. For instance, a manager may have permission to add or delete a defect-tracking ticket, while a lower-level employee may only be allowed to add notes or advance state of the ticket in a workflow. Or certain employees may have elevated access to certain email accounts or sensitive human resources related documents. Each time an employee arrives, leaves, or changes roles, different sets of SaaS user accounts may need to be added, deleted, or updated. Thus, many businesses are facing a crisis of complexity, as they attempt to manage roles in permissions across a relatively large organization using a relatively large number of SaaS services with relatively fine-grained feature-access controls.

These issues may be mitigated by some embodiments of the computing environment 30, which includes an identity management system 32 that manages roles and permissions on a plurality of different third-party SaaS applications 34 and 36. In some cases, the SaaS applications may be accessed by users having accounts and various roles, subject to various permissions, on user computing devices 38, 40, or 42, and those accounts may be managed by an administrator operating administrator computing device 44. In some cases, the user computing devices and administrator computing device may be computing devices operated by a single entity, such as a single entity within a single local area network or domain. Or in some cases, the user computing devices 38, 40, and 42 may be distributed among a plurality of different local area networks, for instance, within an organization having multiple networks. In the figure, the number of third-party application servers and user computing devices is two and three respectively, but it should be appreciated that commercial use cases are expected to involve substantially more instances of such devices. Expected use cases involve more than 10 third-party SaaS applications, and in many cases more than 20 or 50 third-party SaaS applications or on-premises applications. Similarly, expected use cases involve more than 1,000 user computing devices, and in many cases more than 10,000 or more than 50,000 user computing devices. In some cases, the number of users is expected to scale similarly, in some cases, with users transitioning into new roles at a rate exceeding 10 per day, and in many commercially relevant use cases, exceeding 100 or 1,000 per day on average. Similarly, versioning of third-party APIs and addition or subtraction of third-party APIs is expected to result in new APIs or new versions of APIs being added monthly or more often in some use cases.

In some embodiments, the user computing devices 38, 40, and 42 may be operated by users accessing or seeking access to the third-party SaaS applications, and administrator computing device 44 may be operated by a system administrator that manages that access. In some embodiments, such management may be facilitated with the identity management system 32, which in some cases, may automatically create, delete, or modify user accounts on various subsets or all of the third-party SaaS applications in response to users being added to, removed from, or moved between, roles in an organization. In some embodiments, each role may be mapped to a plurality of account configurations for the third-party SaaS applications. In some embodiments, in response to a user changing roles, the administrator may indicate that change in roles via the administrator computing device 44, in a transmission to the identity management system 32.

In response to this transmission, the identity management system may retrieve from memory and updated set of account configurations for the user in the new role, and records of these new account configurations may be created in a graph database in the identity management system 32. That graph database and the corresponding records may be synchronized with corresponding third-party applications 34 and 36 to implement the new account configurations, for instance, using the techniques described above. Further, in some cases, a new deployment of the identity management system 32 may contain a graph database populated initially by extracting data from the third-party SaaS applications and translating that data into a canonical format suitable for the graph database using the techniques described above. In some embodiments, the third-party SaaS applications may include an API server 60 and a web server 62.

In some embodiments, each of the third-party SaaS applications are at different domains, having different subnetworks, at different geographic locations, and are operated by different entities. In some embodiments, a single entity may operate multiple third-party SaaS applications, for instance, at a shared data center, or in some cases, a different third-party may host the third-party SaaS applications on behalf of multiple other third parties. In some embodiments, the third-party SaaS applications may be geographically and logically remote from the identity management system 32 and each of the computing devices 38, 40, 42, and 44. In some embodiments, these components 32 through 42 may communicate with one another via various networks, including the Internet 46 and various local area networks.

In some embodiments, the identity management system 32 includes a controller 48, a data synchronization module 50, a rules engine 52, and identity repository 54, a rules repository 56, and a connector schema repository 58. In some embodiments, the controller 48 may execute the process 10 described above with reference to FIG. 1 and the above-described process by which third-party SaaS application accounts are managed, in some cases by communicating with the various other modules of the identity management system and the other components of the computing environment 30. In some embodiments, the data synchronization module 50 may be configured to synchronize records in the identity repository 54 with records in the third-party SaaS applications, for instance by translating those records at the direction of the controller 48, using the process 10 of FIG. 1 to or from API commands or responses respectively.

In some embodiments, the rules engine 52 may be configured to update the identity repository 54 based on rules in the rules repository 56 to determine third-party SaaS application account configurations based on changes in roles of users, for instance received from the administrator computing device 44, at the direction of controller 48. In some embodiments, the administrator computing device 44 may send a command to transition a user from a first role to a second role, for instance, a command indicating the user has moved from a first-level technical support position to a management position. In response, the controller 48 may retrieve a set of rules (which may also be referred to as a “policy”) corresponding to the former position and a set of rules corresponding to the new position from the rules repository 46. In some embodiments, these sets of rules may indicate which SaaS applications should have accounts for the corresponding user/role and configurations of those accounts, like permissions and features to enable or disable. In some embodiments, these rules may be sent to the rules engine 52, which may compare the rules to determine differences from a current state, for instance, configurations to change or accounts to add or remove. In some embodiments, the rules engine 52 may update records in the identity repository 54 to indicate those changes, for instance, removing accounts, changing groups to which users belong, changing permissions, adding accounts, removing users from groups, and the like. In some embodiments, these updates may be updates to a graph data structure, like the examples described above. In some embodiments, the graph data structure may be a neo4j graph database available from Neo Technology, Inc. of San Mateo, Calif. In some embodiments, the controller 48 may respond to these updates by instructing the data sync module 52 translate the modified nodes and edges into API commands, using a variant of the process 10 of FIG. 1 send those API commands to the corresponding third-party SaaS applications.

In some embodiments, the identity repository 54 may include a graph data structure indicating various entities and relationships between those entities that describe user accounts, user roles within an organization, and the third-party SaaS applications. For instance, some embodiments may record as entities in the graph data structure the third-party SaaS applications, accounts of those applications, groups of user accounts (in some cases in a hierarchical taxonomy), groups of users in an organization (again, in some cases in a hierarchical taxonomy, like an organizational structure), user accounts, and users. Each of these nodes may have a variety of attributes, like the examples described above, e.g., user names for user accounts, user identifiers for users, group names, and group leaders for groups, and the like. In some embodiments, the graph data structure may be a neo4j graph database available from Neo Technology, Inc. of San Mateo, Calif.

In some embodiments, these nodes may be related to one another through various relationships that may be encoded as edges of the graph. For instance, an edge may indicate that a user is a member of a subgroup, and that that subgroup is a member of a group of subgroups. Similarly, and edge may indicate that a user has an account, and that the account is a member of a group of accounts, like a distribution list. In some examples, and edge may indicate that an account is with a SaaS application, with the respective edge linking between a node corresponding to the particular account and another node corresponding to the SaaS application. In some embodiments, multiple SaaS applications may be linked by edges to a node corresponding to a given party, such as a third-party.

In some embodiments, this data structure is expected to afford relatively fast operation by computing systems for certain operations expected to be performed relatively frequently by the identity management system 32. For instance, some embodiments may be configured to relatively quickly query all accounts of the user by requesting all edges of the type “has_an_account” connected to the node corresponding to the user, with those edges identifying the nodes corresponding to the respective accounts. In another example, all members of a group may be retrieved relatively quickly by requesting all nodes connected to a node correspond to the group by an edge that indicates membership. Thus, the graph data structure may afford relatively fast operation compared to many traditional systems based on relational databases in which such relationships are evaluated by cumbersome join operations extending across several tables or by maintaining redundant indexes that slow updates. (Though, embodiments are also consistent with use of relational databases instead of graph databases, as multiple, independently useful inventions are described).

Some embodiments of the identity management system may implement techniques to designate sets of tasks as sequential and execute them in sequence, while executing other tasks concurrently, as described in a U.S. Patent Application titled DISTRIBUTED PROCESSING OF MIXED SERIAL AND CONCURRENT WORKLOADS, filed on the same day as this filing, bearing the attorney docket number 043979-0448280, the contents of which are hereby incorporated by reference.

Some embodiments of the identity management system may implement techniques to organize schemas for a graph database within a set of hierarchical documents that define polymorphic schemas with inheritance described, as described in a U.S. Patent Application titled SCHEMAS TO DECLARE GRAPH DATA MODELS, filed on the same day as this filing, bearing the attorney docket number 043979-0448281, the contents of which are hereby incorporated by reference.

Some embodiments of the identity management system may implement techniques to process a dynamic API request that accommodates different contexts of different requests corresponding to different graph database schemas, as described in a U.S. Patent Application titled EXPOSING DATABASES VIA APPLICATION PROGRAM INTERFACES, filed on the same day as this filing, bearing the attorney docket number 043979-0448282, the contents of which are hereby incorporated by reference.

Some embodiments of the identity management system may implement techniques to implement homomorphic translation programs for translating between schemas, as described in a U.S. Patent Application titled SELF-RECOMPOSING PROGRAM TO TRANSFORM DATA BETWEEN SCHEMAS, filed on the same day as this filing, bearing the attorney docket number 043979-0448283, the contents of which are hereby incorporated by reference.

FIG. 4 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to costs constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs.

The present techniques will be better understood with reference to the following enumerated clauses:

1. A method, comprising: obtaining, with one or more processors, a first application-program interface (API) response from a first software-as-a-service (SaaS) application API, the first API response being arranged according to a first data-serialization format; retrieving, with one or more processors, a first connector schema from memory based on a mapping in memory of the first connector schema to the first SaaS application API, wherein the first connector schema comprises a plurality of rules by which API responses from the first SaaS API are processed to form nodes or edges of a graph data structure; applying, with one or more processors, the rules of the first connector schema to at least part of the first API response from the first SaaS application API to form a plurality of nodes and a plurality of edges of the graph data structure; and updating, with one or more processors, the graph data structure in memory to include the plurality of nodes and the plurality of edges.
2. The method of clause 1, wherein applying the rules of the first connector schema to the first API response comprises: determining that at least some of the rules of the first connector schema call for data related to each of a plurality of entities in the first API response, wherein the related data is not present in the first API response, and wherein the plurality of entities correspond to respective members of a first set of nodes of the graph data structure; in response to the determination, for each of the plurality of entities, querying the data related to the respective entity from data based on another API response from the first SaaS application API; obtaining query results, each of at least some of the query results indicating a relationship between a member of the first set of nodes and a member of a second set of nodes of the graph data structure; and based on the query results, forming edges encoding relationships between members of the first set of nodes and members of the second set of nodes.
3. The method of clause 2, wherein: the first API response includes a user account of the first SaaS application, the user account having respective user identifier; the at least some of the rules of the first connector schema call for user groups to which a user of the user account belongs; the data based on another API response includes one or more API responses indicating for a group, a plurality of user identifiers of users in the group; obtaining query results comprises determining that a respective user identifier is among the plurality of user identifiers of users in the group; and forming edges encoding relationships comprises forming an edge between a node representing the user or user account and a node representing the group, the edge indicating membership of the user or user account in the group.
4. The method of any of clauses 1-3, comprising: obtaining a second API response from a second SaaS application API, the second API response having a different, second data-serialization format from the first data-serialization format; retrieving a second connector schema from memory based on a mapping in memory of the second connector schema to the second SaaS application API, wherein the second connector schema contains at least some rules that are different from the first connector schema; applying the rules of the second connector schema to the second API response from the second SaaS application API to form another plurality of nodes and another plurality of edges of the graph data structure; and updating the graph data structure in memory to include the other plurality of nodes and the other plurality of edges.
5. The method of any of clauses 1-4, wherein applying the rules of the first connector schema comprises: for each item in a set encoded in the first API response from the first SaaS application API, querying the first SaaS application API or the graph data structure with an API request or graph database query, respectively, including the item as an argument.
6. The method of any of clauses 1-5, wherein applying the rules of the first connector schema comprises: querying the first SaaS application API with an API request; receiving a second API response from the first SaaS application API; applying the rules of the first connector schema to the second API response to form at least some of the plurality of nodes or the plurality of edges.
7. The method of any of clauses 1-6, wherein applying the rules of the first connector schema comprises: recursively traversing a tree data structure in which the rules are encoded with a depth-first traversal.
8. The method of any of clauses 1-7, wherein applying the rules of the first connector schema comprises: sending a set of API commands to the first SaaS application API and receiving a set of API responses after obtaining the first API response.
9. The method of clause 8, wherein each member of the set of API responses comprises a respective list of user-account attributes of user accounts the SaaS applications, and wherein updating the graph data structure comprises identifying relationships between nodes in the graph data structure indicated by corresponding values in the list.
10. The method of clause 8, wherein the set of API commands comprise: an API command requesting user accounts associated with a SaaS subscription; an API command requesting a group of the user accounts; and an API command requesting a profile of a given user account.
11. The method of any of clauses 1-10, wherein the first API response is obtained in a hierarchical serialized data format from the first SaaS application API, and wherein applying the rules comprises: parsing the hierarchical serialized data format to obtain a set of key-value pairs, some of the values corresponding to respective pluralities of key-value pairs; changing the name of keys in key-value pairs in the first API response; and normalizing at least some values in key-value pairs in the first API response.
12. The method of any of clauses 1-11, wherein applying the rules of the first connector schema comprises: determining that a given entity listed in the first API response has a given group membership, the given group corresponding to a plurality of entities having the same attribute; and in response to the determination, sending a query pertaining to the given group to a graph database storing at least part of the graph data structure.
13. The method of any of clauses 1-12, comprising: obtaining a second API response from the first SaaS application API; identifying a first item in the first API response; identifying a second item in the second API response; determining a relationship between the first item and the second item based on the first API response and the second API response; and updating the graph data structure in memory to include an edge indicating the relationship, the edge linking a node representing the first item and a node representing the second item.
14. The method of any of clauses 1-13, wherein the graph data structure is a graph database having index free adjacency such that each node contains a reference to each node adjacent the respective node.
15. The method of any of clauses 1-14, comprising: querying the graph data structure for a node representing a user group; obtaining a given group node responsive to the query; identifying members of the group from the graph data structure based on a local index associated with the given group node listing adjacent nodes; forming an API request having an attribute of least some of the identified members as an argument based on the first connector schema; and sending the API request to the first SaaS application API.
16. The method of any of clauses 1-15, wherein updating the graph data structure comprises steps for accelerating a query of a graph.
17. The method of any of clauses 1-16, wherein: obtaining the first API response comprises steps for obtaining an API response from one of a plurality of different APIs; and applying the rules of the first connector schema comprises steps for translating between a graph data structure and a representational state transfer API.
18. The method of any of clauses 1-17, comprising: receiving a request from a client computing device for content; accessing the graph data structure to retrieve at least some of the content; and sending a response to the client computing device including content based at least in part on data retrieved from the graph data structure.
19. The method of any of clauses 1-18, wherein: the graph data structure comprises: group nodes representing groups of users in an organization having a set of permissions; user nodes representing users in the organization; account nodes representing SaaS accounts of the users; edges between group nodes and user nodes indicating user membership in the groups; and edges between user nodes and account nodes indicating which SaaS accounts are assigned to which users; the method comprises: receiving a new user and a role of the user; determining a plurality of SaaS application accounts for the new user based on a mapping in memory between the role and the accounts; updating the graph data structure to include nodes and edges indicating the plurality of SaaS application accounts; forming a plurality of API commands to a plurality of SaaS application APIs at a plurality of different domains based on a plurality of connector schemas, each corresponding to different respective SaaS application; and sending the plurality of API commands to the plurality of different domains to create plurality of SaaS application accounts.
20. A system, comprising: one or more processors; and memory storing instructions that when executed by at least some of the processors effectuate operations comprising: obtaining a first application-program interface (API) response from a first software-as-a-service (SaaS) application API, the first API response being arranged according to a first data-serialization format; retrieving a first connector schema from memory based on a mapping in memory of the first connector schema to the first SaaS application API, wherein the first connector schema comprises a plurality of rules by which API responses from the first SaaS API are processed to form nodes or edges of a graph data structure; applying the rules of the first connector schema to at least part of the first API response from the first SaaS application API to form a plurality of nodes and a plurality of edges of the graph data structure; and updating the graph data structure in memory to include the plurality of nodes and the plurality of edges.
21. The system of clause 20, wherein applying the rules of the first connector schema to the first API response comprises: determining that at least some of the rules of the first connector schema call for data related to each of a plurality of entities in the first API response, wherein the related data is not present in the first API response, and wherein the plurality of entities correspond to respective members of a first set of nodes of the graph data structure; in response to the determination, for each of the plurality of entities, querying the data related to the respective entity from data based on another API response from the first SaaS application API; obtaining query results, each of at least some of the query results indicating a relationship between a member of the first set of nodes and a member of a second set of nodes of the graph data structure; and based on the query results, forming edges encoding relationships between members of the first set of nodes and members of the second set of nodes.
22. The system of any of clauses 20-21, wherein applying the rules of the first connector schema comprises: sending a set of API commands to the first SaaS application API and receiving a set of API responses after obtaining the first API response, wherein: each member of the set of API responses comprises a respective list of user-account attributes of user accounts the SaaS applications, and updating the graph data structure comprises identifying relationships between nodes in the graph data structure indicated by corresponding values in the list.
23. The system of any of clauses 20-22, wherein the first API response is obtained in a hierarchical serialized data format from the first SaaS application API, and wherein applying the rules comprises: parsing the hierarchical serialized data format to obtain a set of key-value pairs, some of the values corresponding to respective pluralities of key-value pairs; changing the name of keys in key-value pairs in the first API response; and normalizing at least some values in key-value pairs in the first API response.
24. The system of any of clauses 20-23, wherein the graph data structure is a graph database having index free adjacency such that each node contains a reference to each node adjacent the respective node.
25. A tangible, non-transitory, machine-readable medium storing instructions that when executed by a data processing apparatus cause the data processing apparatus to perform operations comprising: the operations of any of clauses 1-24.

What is claimed is:

1. A method, comprising:
obtaining, with one or more processors, a first application-program interface (API) response from a first software-as-a-service (SaaS) application API, the first API response being arranged according to a first data-serialization format;
retrieving, with one or more processors, a first connector schema from memory based on a mapping in memory of the first connector schema to the first SaaS application API, wherein the first connector schema comprises a plurality of rules by which API responses from the first SaaS API are processed to form nodes or edges of a graph data structure;
applying, with one or more processors, the rules of the first connector schema to at least part of the first API response from the first SaaS application API to form a plurality of nodes and a plurality of edges of the graph data structure; and
updating, with one or more processors, the graph data structure in memory to include the plurality of nodes and the plurality of edges.

2. The method of claim 1, wherein applying the rules of the first connector schema to the first API response comprises:
determining that at least some of the rules of the first connector schema call for data related to each of a plurality of entities in the first API response, wherein the related data is not present in the first API response, and wherein the plurality of entities correspond to respective members of a first set of nodes of the graph data structure;
in response to the determination, for each of the plurality of entities, querying the data related to the respective entity from data based on another API response from the first SaaS application API;
obtaining query results, each of at least some of the query results indicating a relationship between a member of the first set of nodes and a member of a second set of nodes of the graph data structure; and
based on the query results, forming edges encoding relationships between members of the first set of nodes and members of the second set of nodes.

3. The method of claim 2, wherein:
the first API response includes a user account of the first SaaS application, the user account having respective user identifier;
the at least some of the rules of the first connector schema call for user groups to which a user of the user account belongs;
the data based on another API response includes one or more API responses indicating for a group, a plurality of user identifiers of users in the group;
obtaining query results comprises determining that a respective user identifier is among the plurality of user identifiers of users in the group; and
forming edges encoding relationships comprises forming an edge between a node representing the user or user account and a node representing the group, the edge indicating membership of the user or user account in the group.

4. The method of claim 1, comprising:
obtaining a second API response from a second SaaS application API, the second API response having a different, second data-serialization format from the first data-serialization format;
retrieving a second connector schema from memory based on a mapping in memory of the second connector schema to the second SaaS application API, wherein the second connector schema contains at least some rules that are different from the first connector schema;
applying the rules of the second connector schema to the second API response from the second SaaS application API to form another plurality of nodes and another plurality of edges of the graph data structure; and
updating the graph data structure in memory to include the other plurality of nodes and the other plurality of edges.

5. The method of claim 1, wherein applying the rules of the first connector schema comprises:
for each item in a set encoded in the first API response from the first SaaS application API, querying the first SaaS application API or the graph data structure with an API request or graph database query, respectively, including the item as an argument.

6. The method of claim 1, wherein applying the rules of the first connector schema comprises:
querying the first SaaS application API with an API request;
receiving a second API response from the first SaaS application API;
applying the rules of the first connector schema to the second API response to form at least some of the plurality of nodes or the plurality of edges.

7. The method of claim 1, wherein applying the rules of the first connector schema comprises:
recursively traversing a tree data structure in which the rules are encoded with a depth-first traversal.

8. The method of claim 1, wherein applying the rules of the first connector schema comprises:
sending a set of API commands to the first SaaS application API and receiving a set of API responses after obtaining the first API response.

9. The method of claim 8, wherein each member of the set of API responses comprises a respective list of user-account attributes of user accounts the SaaS applications, and wherein updating the graph data structure comprises identifying relationships between nodes in the graph data structure indicated by corresponding values in the list.

10. The method of claim 8, wherein the set of API commands comprise:
an API command requesting user accounts associated with a SaaS subscription;
an API command requesting a group of the user accounts; and
an API command requesting a profile of a given user account.

11. The method of claim 1, wherein the first API response is obtained in a hierarchical serialized data format from the first SaaS application API, and wherein applying the rules comprises:
parsing the hierarchical serialized data format to obtain a set of key-value pairs, some of the values corresponding to respective pluralities of key-value pairs;
changing the name of keys in key-value pairs in the first API response; and
normalizing at least some values in key-value pairs in the first API response.

12. The method of claim 1, wherein applying the rules of the first connector schema comprises:
determining that a given entity listed in the first API response has a given group membership, the given group corresponding to a plurality of entities having the same attribute; and
in response to the determination, sending a query pertaining to the given group to a graph database storing at least part of the graph data structure.

13. The method of claim 1, comprising:
obtaining a second API response from the first SaaS application API;
identifying a first item in the first API response;
identifying a second item in the second API response;
determining a relationship between the first item and the second item based on the first API response and the second API response; and
updating the graph data structure in memory to include an edge indicating the relationship, the edge linking a node representing the first item and a node representing the second item.

14. The method of claim 1, wherein the graph data structure is a graph database having index free adjacency such that each node contains a reference to each node adjacent the respective node.

15. The method of claim 1, comprising:
querying the graph data structure for a node representing a user group;
obtaining a given group node responsive to the query;
identifying members of the group from the graph data structure based on a local index associated with the given group node listing adjacent nodes;
forming an API request having an attribute of least some of the identified members as an argument based on the first connector schema; and
sending the API request to the first SaaS application API.

16. The method of claim 1, wherein updating the graph data structure comprises steps for accelerating a query of a graph.

17. The method of claim 1, wherein:
obtaining the first API response comprises steps for obtaining an API response from one of a plurality of different APIs; and
applying the rules of the first connector schema comprises steps for translating between a graph data structure and a representational state transfer API.

18. The method of claim 1, comprising:
receiving a request from a client computing device for content;
accessing the graph data structure to retrieve at least some of the content; and
sending a response to the client computing device including content based at least in part on data retrieved from the graph data structure.

19. The method of claim 1, wherein:
the graph data structure comprises:
group nodes representing groups of users in an organization having a set of permissions;
user nodes representing users in the organization;
account nodes representing SaaS accounts of the users;
edges between group nodes and user nodes indicating user membership in the groups; and
edges between user nodes and account nodes indicating which SaaS accounts are assigned to which users;
the method comprises:
receiving a new user and a role of the user;
determining a plurality of SaaS application accounts for the new user based on a mapping in memory between the role and the accounts;
updating the graph data structure to include nodes and edges indicating the plurality of SaaS application accounts;
forming a plurality of API commands to a plurality of SaaS application APIs at a plurality of different domains based on a plurality of connector schemas, each corresponding to different respective SaaS application; and
sending the plurality of API commands to the plurality of different domains to create plurality of SaaS application accounts.

20. A system, comprising:
one or more processors; and
memory storing instructions that when executed by at least some of the processors effectuate operations comprising:
obtaining a first application-program interface (API) response from a first software-as-a-service (SaaS) application API, the first API response being arranged according to a first data-serialization format;
retrieving a first connector schema from memory based on a mapping in memory of the first connector schema to the first SaaS application API, wherein the first connector schema comprises a plurality of rules by which API responses from the first SaaS API are processed to form nodes or edges of a graph data structure;
applying the rules of the first connector schema to at least part of the first API response from the first SaaS application API to form a plurality of nodes and a plurality of edges of the graph data structure; and
updating the graph data structure in memory to include the plurality of nodes and the plurality of edges.

21. The system of claim 20, wherein applying the rules of the first connector schema to the first API response comprises:
determining that at least some of the rules of the first connector schema call for data related to each of a plurality of entities in the first API response, wherein the related data is not present in the first API response, and wherein the plurality of entities correspond to respective members of a first set of nodes of the graph data structure;
in response to the determination, for each of the plurality of entities, querying the data related to the respective entity from data based on another API response from the first SaaS application API;
obtaining query results, each of at least some of the query results indicating a relationship between a member of the first set of nodes and a member of a second set of nodes of the graph data structure; and
based on the query results, forming edges encoding relationships between members of the first set of nodes and members of the second set of nodes.

22. The system of claim 20, wherein applying the rules of the first connector schema comprises:
sending a set of API commands to the first SaaS application API and receiving a set of API responses after obtaining the first API response, wherein:
each member of the set of API responses comprises a respective list of user-account attributes of user accounts the SaaS applications, and
updating the graph data structure comprises identifying relationships between nodes in the graph data structure indicated by corresponding values in the list.

23. The system of claim 20, wherein the first API response is obtained in a hierarchical serialized data format from the first SaaS application API, and wherein applying the rules comprises:
parsing the hierarchical serialized data format to obtain a set of key-value pairs, some of the values corresponding to respective pluralities of key-value pairs;
changing the name of keys in key-value pairs in the first API response; and
normalizing at least some values in key-value pairs in the first API response.

24. The system of claim 20, wherein the graph data structure is a graph database having index free adjacency such that each node contains a reference to each node adjacent the respective node.
